(19) United States
(12) Patent Application Publication
(10) Pub. No.: US 2011/0106982 A1
(43) Pub. Date: May 5, 2011

(54) HOST ACCOMMODATING MULTIPLE USERS AND USER STATIONS THEREFOR

(76) Inventors: Zuri Guzikevits, Tel Aviv (IL); Nathan Berkovitch, Rishon LeZion (IL); David Sussan, Nave Yahud Monuson (IL)

(21) Appl. No.: 12/883,227

(22) Filed: Sep. 16, 2010

Related U.S. Application Data
(60) Provisional application No. 61/256,970, filed on Oct. 31, 2009.

(51) Int. Cl. G06F 13/10

(52) U.S. Cl. 710/15

(57) ABSTRACT

A host and multiple user stations form a system that provides computer functionality to multiple users by equipping the host with a host multifunction unit and by equipping the user stations with station multifunction units. Both the host and the station multifunction units have communication units and processing circuitry. The communication unit of the host interfaces with the communication units of the user stations to enable mutual signal exchange. The processing circuitry of the host multifunction unit enables the CPU of the host to send and receive signals to and from the user stations. The processing circuitry of the station multifunction units enables signals sent from the host to be forwarded to a display unit of the user station. The processing circuitry of the station multifunction units also enables signals from an input unit of the user stations to be forwarded to the host.

### RELATED APPLICATION

This application claims priority under 35 U.S.C. §119(e) to U.S. Provisional Application No. 61/256,970, filed Oct. 31, 2009, which is hereby incorporated by reference in its entirety.

### BACKGROUND

Modern personal computers (PCs) use very powerful processing hardware and software, and often such resources are under-utilized by uses. That is, often users do not need nor use the full extent of their personal computers processing power. For example, a present-day personal computer used for Internet surfing typically consumes only small part of the total personal computer's computing resources. The under use of a personal computer's full power is an unnecessary expense, which increases as the number of personal computers in a household or office increases. A typical home may have four personal computers networked together, each personal computer running an operating system and user applications and maintaining separate storage. Management of networked personal computers may include software support and backup on each of the personal computers separately, and such software management may be too complex for many ordinary users.

One solution considered for serving multiple users more efficiently is a system that implements a thin client for each user and a server to manage much of the desired functionality, such as hosting applications and storing data. Each thin client runs an operating system that may be regarded as a stripped down, low performance personal computer operating system. A multiple-user personal computer is another available solution that supports multiple displays and other peripherals. The displays are connected to multiple graphic modules within the personal computer, and additional peripherals, such as keyboards, are connected to the personal computer at a USB port. A drawback of such a system is the cluttered environment created as a result of all the cables connecting each thin client to the personal computer. Reference is made to FIG. 1, which illustrates this phenomenon.

FIG. 1 presents a configuration of a prior art system 10 of a first, second, and third user station 12a, 12b, 12c, respectively, connected to a single personal computer 14 as their host. Although three user stations are presented in FIG. 1, similar systems may be implemented with fewer or with more user stations. Each of user stations 12a, 12b, 12c has a display 16a, 16b, 16c and a USB hub 18a, 18b, 18c connecting to a keyboard 20a, 20b, 20c and a mouse 22a, 22b, 22c, respectively. The personal computer 14 has installed therein a plurality of graphic cards 24 and a USB card 26. One graphics card may be associated with one or two displays. Each display 16a, 16b, 16c is connected to one of the graphic cards 24 via a dedicated cable 28a, 28b, 28c, respectively. Each USB hub 18a, 18b, 18c is connected to the USB card 26 via a dedicated cable 30a, 30b, 30c, respectively. As is apparent from FIG. 1, the need for multiple dedicated cables for each user station causes clutter to accumulate rapidly, and the “wired” nature of the connections limit the mobility available to users throughout the household.

Thus, there remains a need for multiple user within a common location, such as a household or an office, to have computer functionality without a significant over-expenditure on hardware and/or software that generally would not be necessary, and it is further desirable that the functionality be provided with none or very little of the clutter associated with wired connections between user stations and their hosts. Additionally desirable would be a solution that facilitates easy mobility for users.

### SUMMARY

The present invention meets the needs identified above that heretofore are not known to the inventors named herein to have been met. That is, the invention provides multiple users within a common location computer functionality at lower costs, with less or none of the clutter associated with connectivity between user stations and their hosts, and with increased mobility for users. The invention may be embodied in multiple forms.

For example, the invention may be embodied as a station multifunction unit having a communication unit, first processing circuitry, and second processing circuitry. The communication unit is adapted to communicate with a host. The first processing circuitry is configured to receive signals from the host via the communication unit, to process the received signals, and to forward the processed signals to a dumb terminal. The second processing circuitry is configured to receive signals from at least one input unit, to process the received signals, and to forward the processed signals to the host via the communication unit.

The invention may also be embodied as a user station that has the station multifunction unit described above and a display unit. The display unit is adapted to receive signals from the first processing circuitry of the station multifunction unit.

The invention may further be embodied as a host multifunction unit that includes a communication unit, first processing circuitry, and second processing circuitry. The communication unit is adapted to communicate with at least one user station. The first processing circuitry is configured to receive signals from a CPU of a host, to process the received signals, and to forward the processed signals to the communication unit for transmission to the at least one user station as input to a dumb terminal. The second processing circuitry is configured to receive signals from communication unit, to process the received signals, and to forward the processed signals to the CPU.

The invention may additionally be embodied as a host that has the host multifunction unit described above and a CPU. The CPU is configured to send signals to the first processing circuitry of the host multifunction card and to receive signals from the second processing circuitry of the host multifunction card.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 illustrates a prior art system of multiple user stations sharing a host;

FIG. 2 illustrates a system of multiple user stations sharing a host in accordance with an embodiment of the invention;

FIG. 3 provides a block diagram of a personal computer that may be implemented as the host in the embodiment of FIG. 2;

FIG. 4 provides a block diagram of another personal computer that may be implemented as an alternative to the personal computer of FIG. 3;

FIG. 5 provides a block diagram of a user station that may be implemented as one of the user stations in the embodiment of FIG. 2;

FIG. 6 provides a block diagram of another user station that may be implemented as one of the user stations in the embodiment of FIG. 2;

FIG. 7 provides a system block diagram representation of the hardware and software for an example embodiment of the invention; and

FIG. 8 illustrates a system of multiple user stations sharing a host in accordance with another embodiment of the invention.

### DETAILED DESCRIPTION

The invention summarized above and defined by the claims below will be better understood by referring to the present detailed description of embodiments of the invention. This description is not intended to limit the scope of claims but instead to provide examples of the invention.

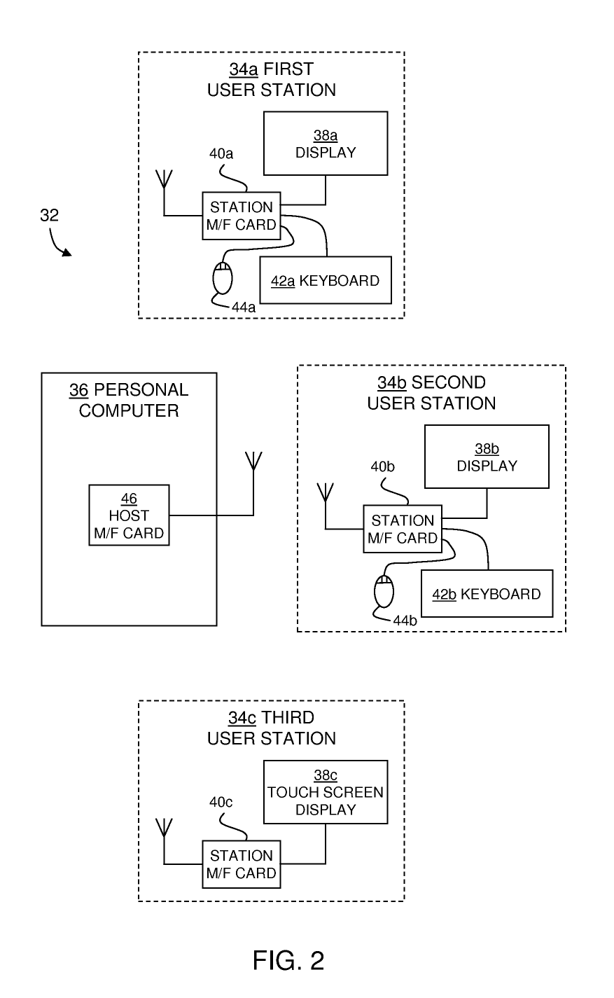

FIG. 2 presents a first implementation of the invention embodied as a system 32 having a first, second, and third user station 34a, 34b, 34c, respectively, connected to a single personal computer 36 as their host. Although three user stations are presented in FIG. 2, similar systems may be implemented with fewer or with more user stations. As non-limiting example components, personal computer 36 may be a known personal computer having as a central processing unit (CPU) such as an Intel Pentium Processor E5400 or instead an Intel Xeon 5130 CPU, and personal computer 36 may use as storage a SATA hard drive or a flash memory SSD. A host multifunction unit within the personal computer 36 and station multifunction units within the first, second, and third user station 34a, 34b, 34c enable wireless communication as discussed in more detail below.

Each of first and second user stations 34a, 34b has a display unit, two input units, and a station multifunction unit. The display units of user stations 34a, 34b are displays 38a, 38b, respectively, which are dumb terminals. That is, displays 38a, 38b have no operating system that communicates with the operating system of the host, personal computer 36. (The displays 38a, 38b may have basic operating systems for controlling the hardware within the displays.) Example dumb terminals suitable for use as displays 38a, 38b include a Benq E2200HD or LG W2261LP.

The station multifunction units are station multifunction cards 40a, 40b, which constitute the user-side elements of the interface between respective displays 38a, 38b and the personal computer 36. Within a user station, the display and the station multifunction card may be implemented as a single integral unit. The station multifunction cards 40a, 40b also constitute a user-side element of the interface between the personal computer 36 and the input units, which in this example are keyboards 42a, 42b and mice 44a, 44b, respectively. Instead of mice 44a, 44b, the cursor position control devices can be trackballs, touchpads, or like elements. A user operating the input units sends signals to the personal computer 36 to control PC-resident applications that are associated with respective user stations. The PC applications then process the signals and send the processed signals to the displays 38a, 38b, as discussed in more detail below. The station multifunction card 40a, 40b may be further configured to accommodate additional accessories, such as audio speakers to play sounds in accordance with signals sent from the personal computer 36. Other example additional accessories include cameras, microphones, and printers.

The third user station 34c has a station multifunction unit and a dumb terminal display unit with built-in input units. Specifically, the display unit is a touch screen display 38c, so it has built-in keys serving as the input units. In other words, the display unit and the input unit of this embodiment constitute a touch screen display. The touch screen display 38 may, for example be a Detaik 1578R or an ACER T230HBMIDH. The station multifunction unit is a station multifunction card 40c, which constitutes the user-side element of the interface between the touch screen display 38 and the personal computer 36. Within the third user station 34c, the touch screen display 38 and the station multifunction card 40c may be implemented as a single integral unit. The station multifunction card 40c may fashioned with further connection functionality (for example, that including sockets or jacks) to enable additional connection with a keyboards and or cursor position control device. The station multifunction card 40c may be further configured to accommodate additional accessories, such as audio speakers to play sounds in accordance with signals sent from the personal computer 36. A user operating the input units of the third user station 34c controls PC-resident applications by sending signals to the personal computer 36 that are processed and then sent to the touch screen display 38c, as discussed in more detail below.

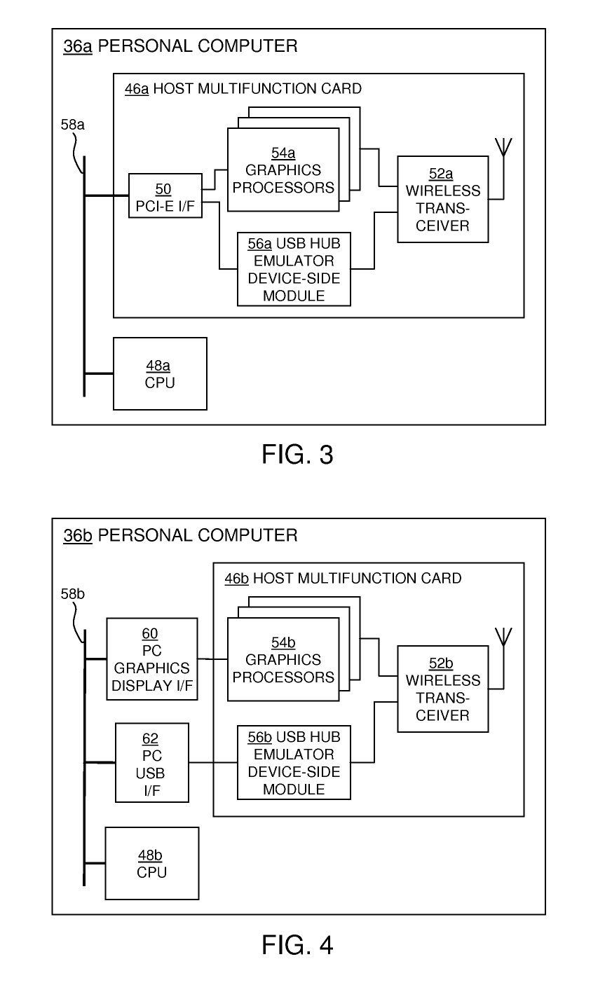

The host multifunction unit within the personal computer 36 is a host multifunction card 46, as shown in FIG. 2. Two example implementations of the host multifunction card 46 are host multifunction cards 46a and 46b, which are described as follows in FIGS. 3 and 4, respectively.

With reference first to FIG. 3, personal computer 36a, the host for a system including the user stations 34a, 34b, 34c, includes the host multifunction card 46a and a CPU 48a. The host multifunction card 46a has a communication unit, processing circuitry, and a PCI-E interface 50. The communication unit is a wireless transceiver 52a, which is adapted to communicate with the user stations. An 802.11n Access Point is an example wireless transceiver that may be used as wireless transceiver 52a. (In alternate embodiments, a femto-cell, having functionality similar to a cellular base station, may be used as the wireless transceiver.)

The configuration of the processing circuitry can be regarded as providing two categories of functionality. In the first category, the processing circuitry receives signals from the CPU 48a, processes the received signals, and forwards the processed signals to the wireless transceiver 52a for transmission to the user stations. In the second category of functionality, the processing circuitry receives signals from the wireless transceiver 52a, processes the received signals, and forwards the processed signals to the CPU 48a. The processing circuitry that provides the aforementioned functionality may be embodied as hardware, software, or firmware and machine instructions coded therein may be stored in an appropriate manner on the host multifunction card 46a. In the host multifunction card 46a, the first category of functionality is provided by one or more graphics processors 54b, for example, an H.264 media processor. It is not necessary to implement more graphics processors than the number of anticipated user stations, and fewer than that number may be implemented. The second category of functionality for the host multifunction card 46a is provided by a USB hub emulator device-side module 56a. The circuitry of the USB hub emulator device-side module 56a operates with corresponding circuitry at the user stations to implement USB hub functionality. Both the graphics processors 54a and the USB hub emulator device-side module 56a connect to the wireless transceiver 52a for sending and receiving, respectively, signals to/from the user stations.

The PCI-E interface 50 communicates with the CPU 48a of the personal computer 36a via a PCI-E data bus 58a. The PCI-E interface 50 transfers (1) signals from the CPU 48a to the graphics processors 54a and (2) other signals from the USB hub emulator device-side module 56a to the CPU 48a.

With reference now to FIG. 4, a personal computer 36b includes a CPU 48b and an alternate implementation of a host multifunction card: a host multifunction card 46b has a communication unit, a wireless transceiver 52b, and processing circuitry providing the two categories of functionality discussed above with respect to the host multifunction card 46a. The processing circuitry that provides the aforementioned functionality may be embodied as hardware, software, or firmware and stored in an appropriate manner. The first category of functionality is provided by one or more graphics processors 54b, and the second category of functionality is provided by a USB hub emulator device-side module 56b. The graphic processors 54b may be high-definition multimedia processor (known also as MPEG4 or ITU H.264).

FIG. 4 shows that the personal computer 36b includes also a PC graphics display interface 60 and a USB interface 62, which communicate with the CPU 48b via a PCI-E main data bus 58b. The graphics processors 54b receive signals from the PC graphics display interface 60, and the USB hub emulator device-side module 56b communicates with the CPU 48b through the PC USB interface 62.

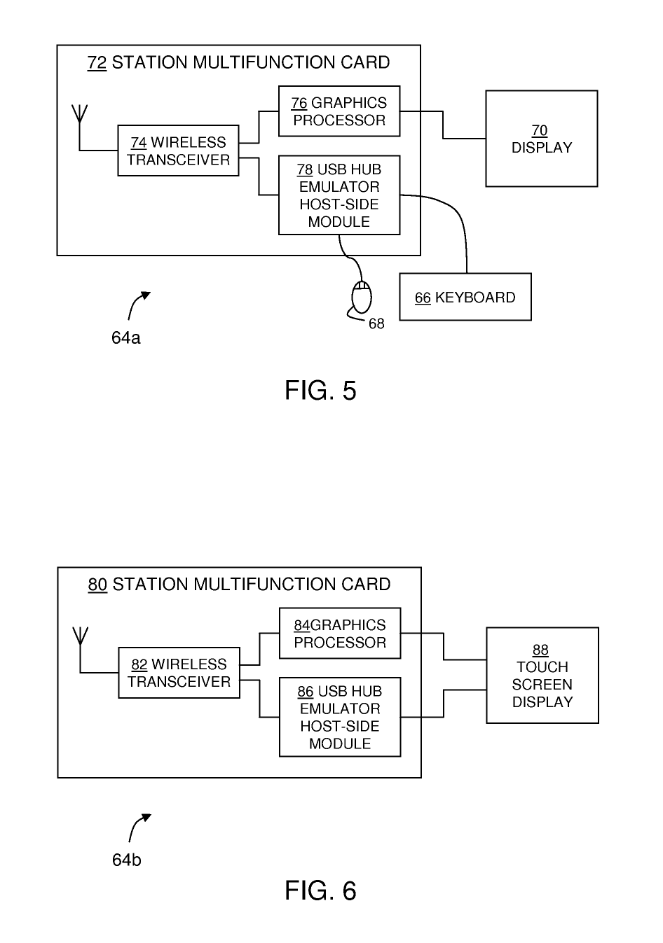

FIG. 5 illustrates a user station 64a having an example implementation of a station multifunction unit and input and output units. Specifically, the input units are a keyboard 66 and a mouse 68, and the output unit is a display 70. The station multifunction unit is a station multifunction card 72, which includes a communication unit and processing circuitry. The communication unit is a wireless transceiver 74, which is adapted to communicate with a host, such as the personal computer 36 in FIG. 2. Example wireless transceivers suitable for the station multifunction card 72 include an IEEE 802.11n station transceiver.

The configuration of the processing circuitry of the station multifunction card 72 can be regarded as providing two categories of functionality. In the first category, the first processing circuitry receives signals from a host via the wireless transceiver 74, processes the received signals, and forwards the processed signals to a display unit, which in this case is the display 70. (Such description is not intended to rule out potential bidirectional control signals traversing between the display 70 and the host personal computer 36 per the supported display interface standard.) In the second category of functionality, the processing circuitry receives signals from the keyboard 66 and the mouse 68, processes the received signals, and forwards the processed signals to the host via the wireless transceiver 74. The processing circuitry may also receive signals from the host via the wireless transceiver 74, process the received signals and forward the processed signals to USB peripherals such as speakers. The processing circuitry that provides the aforementioned functionality may be embodied as hardware, software, or firmware and machine instructions coded therein may be stored in an appropriate manner on the station multifunction card 72. In the station multifunction card 72, the first category of functionality is provided by a graphics processor 76, for example, an ITU H.264 decoder. The second category of functionality for the station multifunction card 72 is provided by a USB hub emulator host-side module 78. The circuitry of the USB hub emulator host-side module 78 operates with the USB hub emulator device-side module at the host to implement USB hub functionality. Both the graphics processor 76 and the USB hub emulator host-side module 78 connect to the wireless transceiver 74 for receiving and sending, respectively, signals from/to a host.

FIG. 6 illustrates a user station 64b as an alternative implementation to user station 64a illustrated in FIG. 5. The user station 64b includes a station multifunction card 80 that has a wireless transceiver 82, and a graphics processor 84, and a USB hub emulator host-side module 86, which can be substantially the same as the analogous elements in the implementation of FIG. 5. Here, however, the display 70, keyboard 66, and mouse 68, are replaced by a touch screen display 88.

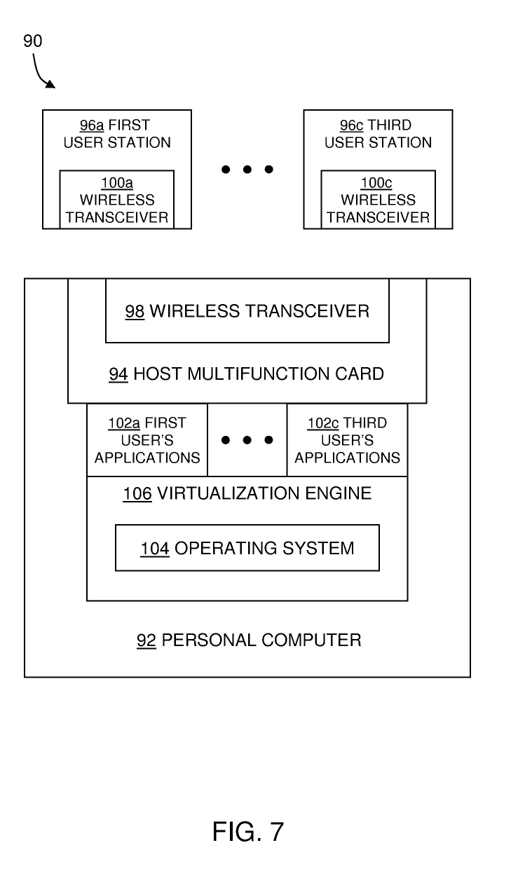

FIG. 7 provides a system block diagram representation of the hardware and software for an example embodiment of the invention. This system 90 includes a host personal computer 92 having a host multifunction card 94 and three user stations 96a-96c each having a user multifunction card (not shown for clarity). The host multifunction card 94 provides a physical platform for a wireless transceiver 98, and the user multifunction cards provide physical platforms for wireless transceivers 100a-100c. Accordingly, the user stations 96a-96c connect wirelessly via their respective wireless transceivers 100a-100c and wireless transceiver 98 to first through third users' applications 102a-102c hosted on the personal computer 92. The personal computer 92 and its operating system 104 in particular are configured to support a plurality of user stations as is known in the art, and an example known configuration is disclosed in U.S. Pat. No. 6,222,529, hereby incorporated by reference in its entirety. The personal computer 92 also has a virtualization engine 106, which creates a virtual version of the operating system 104 for each of the first through third users' applications 102a-102c.

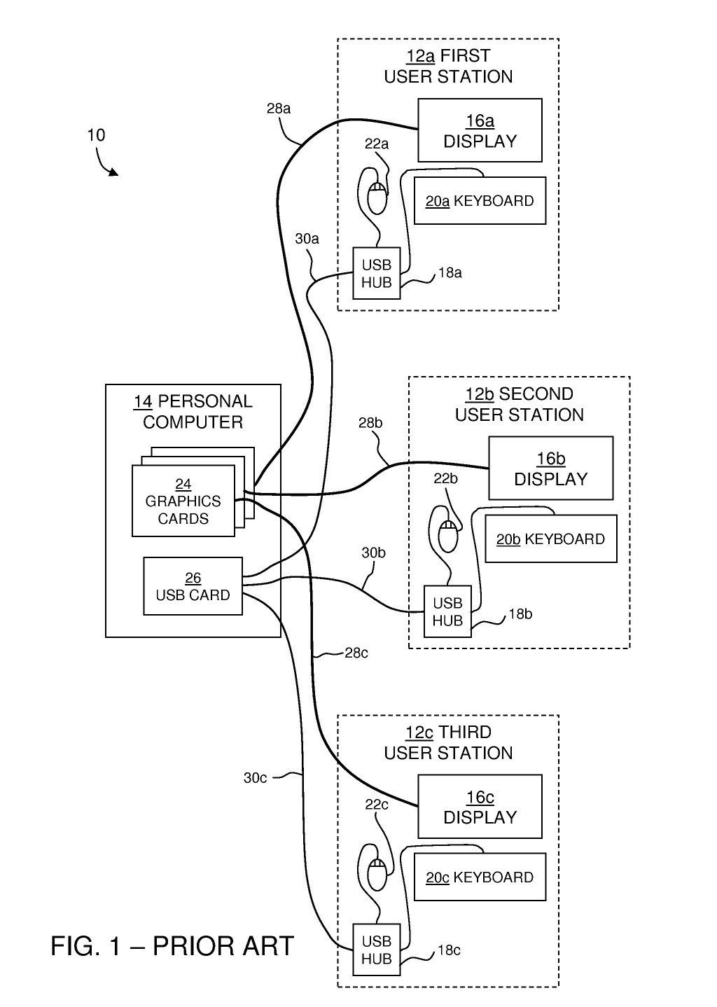

The preceding embodiments show that system implementing the disclosed host multifunction units and station multifunction unit enable the shared usage of a host by users who individually use a display unit and at least one input unit as a user station. Unlike the prior art discussed in FIG. 1, the disclosed communication units manage signals through a shared medium instead of through multiple separate wires.

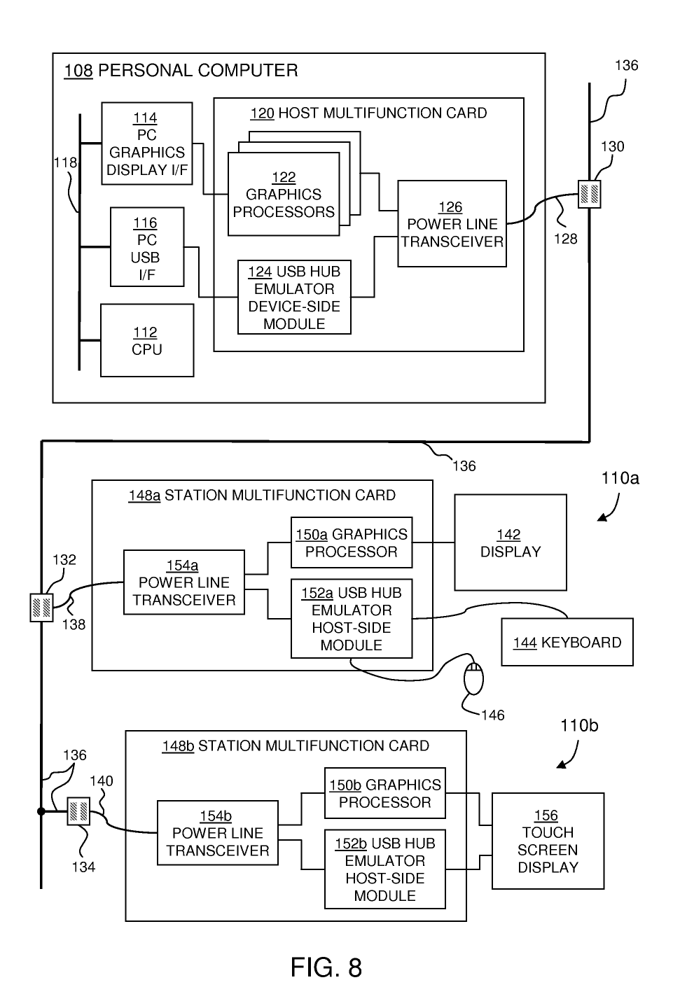

The preceding embodiments implemented wireless communication between the host and user stations, but the invention is not limited accordingly. Reference is now made to FIG. 8, which illustrates a system in which the host and user stations communicate via a power line. Such a system is not prone to the cumbersome clutter of accumulating wires discussed above with respect to FIG. 1, because power lines are generally well concealed within homes and offices.

As shown in FIG. 8, a host, personal computer 108, communicates with two user stations 110a and 110b. The personal computer 108 is similar to personal computer 36b in FIG. 4, as it implements a CPU 112, a PC graphics display interface 114, and a PC USB interface 116. The CPU 112 communicates with the PC graphics display interface 114 and the PC USB interface 116 via a PCI-E main data bus 118. The personal computer 108 also has a host multifunction card 120, which includes graphics processors 122 and a USB hub emulator device-side module 124. The graphics processors 122 receive signals from the CPU 112 via the PC graphics display interface 114, and the USB hub emulator device-side module 124 sends signals to the CPU 112 via the PC USB interface 116.

The host multifunction card 120 additionally has a power line transceiver 126, which is connected to both the graphics processors 122 and the USB hub emulator device-side module 124 and also via a power cord 128 to a power outlet 130. The power outlet 130 is connected to other power outlets 132 and 134 by the power line 136. Such enables the personal computer to communicate with the two user stations 110a and 110b, as the two stations are connected to the power line 136 via power cords 138, 140, to power outlets 132, 134, respectively.

The user station 110a is similar to the user station 64a of FIG. 5, as it implements a dumb terminal display 142, a keyboard 144, and a mouse 146. The user station 110a also has a station multifunction card 148a, which has a graphics processor 150a and a USB hub emulator host-side module 152a. The display 142 is connected to the graphics processor 150a, and the keyboard 144 and mouse 146 are connected to the USB hub emulator host-side module 152a. The station multifunction card 148a also has a power line transceiver 154a, which connects the graphics processor 150a and the USB hub emulator host-side module 152a to the power outlet 132 via the power cord 138.

The user station 110b is similar to the user station 64b of FIG. 6, as it implements a dumb terminal touch screen display 156. The user station 110b also has a station multifunction card 148b, which has a graphics processor 150b and a USB hub emulator host-side module 152b. The touch screen display 156 is connected to both the graphics processor 150b and the USB hub emulator host-side module 152b. The station multifunction card 148b also has a power line transceiver 154b, which connects the graphics processor 150b and the USB hub emulator host-side module 152b to the power outlet 134 via the power cord 140.

Using principles of the present invention, communication between hosts and user stations are not limited to the example embodiments disclosed above. Embodiments may also implement connectivity for example via fiber, coax, phone line, and wired communications such as Ethernet. Users choosing to implement wired communication will not have the proliferation of wires accumulating as in the prior art discussed above with reference to FIG. 1, because only a single wire is needed between the host and a user station instead of two wires. That is, even when implementing wired connectivity, the number of cables used is decreased by half of what it was for the prior art.

The preceding embodiments presented personal computer as hosts, but the invention is not limited accordingly. For example, the host may be a cellular smart phone instead. With such a host, a user may use a screen as in the previous embodiments at the same time that the cellular smart phone is used to execute a phone call or as a computing device.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

We claim:

1. A station multifunction unit comprising:
a communication unit adapted to communicate with a host;
first processing circuitry configured to receive signals from the host via the communication unit, to process the received signals, and to forward the processed signals to a dumb terminal; and
second processing circuitry configured to receive signals from at least one input unit, to process the received signals, and to forward the processed signals to the host via the communication unit.

2. The station multifunction unit of claim 1, wherein the communication unit includes a wireless transceiver.

3. The station multifunction unit of claim 1, wherein the communication unit includes a wired transceiver.

4. The station multifunction unit of claim 1, wherein the first processing circuitry includes a graphics processor.

5. The station multifunction unit of claim 1, wherein the second processing circuitry includes a USB hub emulator host-side module.

6. A user station comprising:
the station multifunction unit of claim 1; and
a display unit adapted to receive signals from the first processing circuitry of the station multifunction unit.

7. The user station of claim 6 further comprising:
at least one input unit adapted to provide signals to the second processing circuitry of the station multifunction unit.

8. The user station of claim 7, wherein the display unit and the at least one input unit constitute a touch screen display.

9. The user station of claim 7, wherein the at least one input unit includes a keyboard and a cursor position control device.

10. A host multifunction unit comprising:
a communication unit adapted to communicate with at least one user station;
first processing circuitry configured to receive signals from a CPU of a host, to process the received signals, and to forward the processed signals to the communication unit for transmission to the at least one user station as input to a dumb terminal; and
second processing circuitry configured to receive signals from communication unit, to process the received signals, and to forward the processed signals to the CPU.

11. The host multifunction unit of claim 10, wherein the communication unit include a wireless transceiver.

12. The host multifunction unit of claim 10, wherein the communication unit include a wired transceiver.

13. The host multifunction unit of claim 10, wherein the first processing circuitry includes at least one graphics processor.

14. The host multifunction unit of claim 10, wherein the second processing circuitry includes a USB hub emulator device-side module.

15. The host multifunction unit of claim 10, wherein:
the communication unit is further adapted to communicate with at least two user stations;
the first processing circuitry is further configured to receive signals from the CPU of the host, to process the received signals, and to forward the processed signals to the communication unit for transmission to the at least two user stations; and
the host multifunction unit enables the at least two user stations to have shared usage of the host.

16. The host multifunction unit of claim 10 further comprising:
a PCI-E interface operative (1) to transfer signals from the CPU of the host to the first processing circuitry and (2) to transfer signals from the second processing circuitry to the CPU of the host.

17. The host multifunction unit of claim 10, wherein:
the first processing circuitry is further configured to receive signals from the CPU of the host through a graphics interface of the host; and
the second processing circuitry is further configured to forward signals to the CPU through a USB interface of the host.

18. A host comprising:
the host multifunction unit of claim 10; and
a CPU configured to send signals to the first processing circuitry of the host multifunction card and to receive signals from the second processing circuitry of the host multifunction card.

19. The host of claim 18, wherein the host is a personal computer.

20. The host of claim 18, wherein the host is a cellular smart phone.
